(19) United States
(12) Patent Application Publication
(10) Pub. No.: US 2018/0260208 A1
(43) Pub. Date: Sep. 13, 2018

(54) System of an Electronic Lock for Updating a Firmware of the Electronic Lock

(71) Applicant: Jao Ching Lin, Taipei City (TW)

(72) Inventor: Jao Ching Lin, Taipei City (TW)

(21) Appl. No.: 15/912,674

(22) Filed: Mar. 6, 2018

(30) Foreign Application Priority Data
Mar. 8, 2017 (TW) 106107653

(51) Int. Cl. G06F 8/65; E05B 47/00

(52) U.S. Cl. CPC G06F 8/65; E05B 2047/0057; E05B 47/00

(57) ABSTRACT

A system of an electronic lock for updating a firmware of the electronic lock has an electronic lock with a body. The body has a central processing module, a data transmission interface electrically connected to the central processing module, and at least one read/write memory chip. The data transmission interface has a port formed on a surface of the body. Each one of the at least one read/write memory chip has a firmware program. A firmware file is received from the port of the data transmission interface, and the central processing module loads into the firmware file in a corresponding one of the at least one read/write memory chip to become the firmware program, and this may provide an effect of updating the firmware program of the read/write memory chip from outside easily.

### BACKGROUND OF THE INVENTION

### 1. Field of the Invention

The present invention relates to an electronic lock system, and more particularly to a system of an electronic lock that can update a firmware of the electronic lock from outside via a data transmission interface.

### 2. Description of Related Art

A conventional electronic lock has multiple hardware elements disposed in a body of the conventional electronic lock, such as an input interface, a control interface, a wireless interface, a lock structure driver, and the like. The conventional electronic lock has a memory to store firmware to control the above-mentioned hardware elements. When a central processing module of the conventional electronic lock executes codes of the firmware, the above-mentioned hardware elements can complete the functions.

The firmware stored in the memory of the conventional electronic lock can be read and executed by the central processing module. However, when the conventional electronic lock needs to update the firmware to obtain new functions or correct existing errors, the body of the conventional electronic lock is needed to disassemble and the firmware in the memory of the body is updated by a special loading tool, and this may make the process of updating the firmware of the conventional electronic lock very troublesome and needs improvement. The system of an electronic lock for updating a firmware of the electronic lock in accordance with the present invention mitigates or obviates the aforementioned problems.

### SUMMARY OF THE INVENTION

The main objective of the present invention is to provide a system of an electronic lock for updating a firmware of the electronic lock that that can update a firmware of the electronic lock from outside via a data transmission interface.

The system of an electronic lock for updating a firmware of the electronic lock in accordance with the present invention has an electronic lock with a body. The body has a central processing module, a data transmission interface electrically connected to the central processing module, and at least one read/write memory chip.

The data transmission interface has a port formed on a surface of the body. Each one of the at least one read/write memory chip has a firmware program.

A firmware file is received from the port of the data transmission interface, and the central processing module loads the firmware file in a corresponding one of the at least one read/write memory chip to become the firmware program, and this may provide a effect of updating the firmware program of the read/write memory chip from outside easily.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a system of an electronic lock for updating a firmware of the electronic lock in accordance with the present invention;

FIG. 2 is an operational flow chart of the first embodiment of the system of the electronic lock in FIG. 1; and

FIG. 3 is a block diagram of a second embodiment of a system of an electronic lock for updating a firmware of the electronic lock in accordance with the present invention.

### DETAILED DESCRIPTION OF THE PREFERRED EMBODIMENT

In order to understand the technical features and effects of the present invention in detail, and in accordance with the contents of the specification, the preferred embodiments shown in the figures are further described in detail as follows.

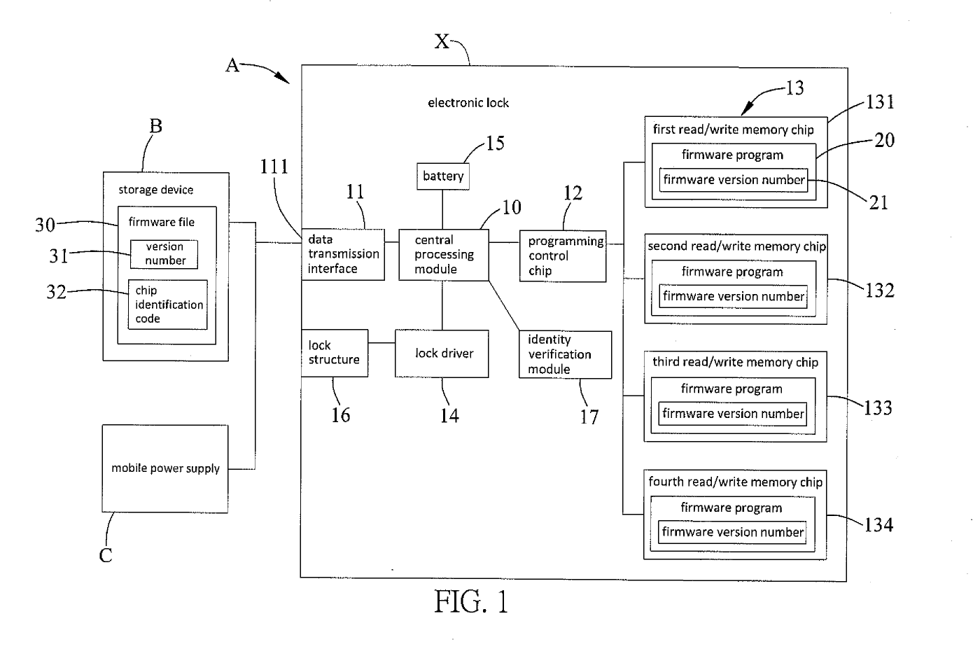

With reference to FIG. 1, a first embodiment of a system of an electronic lock for updating a firmware of the electronic lock in accordance with the present invention has an electronic lock A, a storage device B and a mobile power supply C respectively associated with the electronic lock A.

The electronic lock A has a body X, a central processing module 10, a data transmission interface 11, a programming control chip 12, at least two read/write memory chips 13, a lock driver 14, a battery 15, an identity verification module 17, and a lock structure 16. The central processing module 10 is disposed in the body X. The data transmission interface 11 is electrically connected to the central processing module 10, and may be compatible with USB 1.0, USB 1.1, USB 2.0 or USB 3.0 interface specification USB connector, Type-C USB connector or other special specification connector. The data transmission interface 11 has an port 111 formed on a surface of the body X, and a protecting cover such as a slide cover, a cover or a movable cover is covered on the port 111 to prevent the port 111 from being wetted or contaminated by dust. The programming control chip 12 is electrically connected to the central processing module 10 and may be a de-multiplexer (DEMUX). The at least two read/write memory chips 13 may be EEPROMs, RAMs, or Flash memories, etc., which are both readable and writable. The lock driver 14 is electrically connected to the central processing module 10. The battery 15 is electrically connected to the central processing module 10. The identity verification module 17 is electrically connected to the central processing module 10. The lock structure 16 is electrically connected to the central processing module 10 and the lock driver 14.

The at least two read/write memory chips 13 are included a first read/write memory chip 131, a second read/write memory chip 132, a third read/write memory chip 133, a fourth read/write memory chip 134 and the like. Each read/write memory chip 13 has a firmware program 20 stored in the read/write memory chip 13. Each firmware program 20 has a firmware version number 21. The central processing module 10 may read the firmware program 20 of each read/write memory chip 13 to perform various functions of the electronic lock A. The at least two read/write memory chips 13 are electrically connected to the programming control chip 12.

When the data transmission interface 11 receives a firmware file 30 including a version number 31 and a chip identification code 32 via the port 111, the central processing module 10 selects a corresponding read/write memory chip 13 via the chip identification code 32. Then, the central processing module 10 uses the version number 31 to determine the version of the firmware file 30 is newer than the firmware version number 21 of the corresponding firmware program 20. If the version of the firmware file 30 is newer than the version of the firmware program 20, the programming control chip 12 loads the newer firmware file 30 to the corresponding read/write memory chip 13. For example, the chip identification code 32 of the firmware file 30 inputs into the data transmission interface 11 is corresponding to the first read/write memory chip 131, the central processing module 10 is compared with the version number 31 of the firmware file 30 and the firmware version number 21 of the first read/write memory chip 131. If the version number 31 of the firmware file 30 is newer than the firmware version number 21 of the first read/write memory chip 131, the programming control chip 12 loads the firmware file 30 into the first read/write memory chip 131 to update the firmware program 20 that is stored in the first read/write memory chip 131. If the version number 31 of the firmware file 30 is not newer than the firmware version number 21 of the corresponding firmware program 20, the programming control chip 12 does not operate.

The lock driver 14 is acted to open close the lock structure 16 according to an instruction of the central processing module 10. The identity verification module 17 may be a fingerprint identification module or a keyboard input module. The central processing module 10 determines whether the identity verification module 17 inputs a key or not, so the lock driver 14 is acted to open or close the lock structure 16. Additionally, when the data transmission interface 11 receives the firmware file 30, the central processing module 10 may use the result of the key inputs the identity verification module 17 to determine to load the firmware file 30 into the read/write memory chip 13 or not. The battery 15 is used to supply power to the electronic lock A, and the central processing module 10 performs power management of the battery 15.

The storage device B may be a storage device conforming to the interface specification of USB 1.0, USB 1.1, USB 2.0, or USB 3.0, or a USB storage device of Type-C, such as a USB flash drive or a USB portable hard drive. As described above, a firmware file 30 is stored in the storage device B, and the firmware file 30 is a firmware file that is prepared to be written into a specific read/write memory chip 13 of the electronic lock A. The firmware file 30 has a version number 31 and a chip identification code 32. When the storage device B is electrically connected to the data transmission interface 11 of the electronic lock A via the port 111 that is exposed out of the body X of the electronic lock A, the central processing module 10 may read and determine the storage device B. Whether the storage device B has a firmware file 30 compatible with the format, and if yes, the central processing module 10 may determine the correctness of the key inputs the identity verification module 17 to select a pre-loaded read/write memory chip 13 according to the chip identification code 32 of the firmware file 30. If the version number 31 of the firmware file 30 is newer than the firmware version number 21 of the first read/write memory chip 131, the programming control chip 12 loads the newer firmware file 30 into the read/write memory chip 13.

For example, after the central processing module 10 determining the key inputs from the identity verification module 17, if correct, confirming the chip identification code 32 that is corresponding to the first read/write memory chip 131. The central processing module 10 determines the version number 31 of the firmware file 30 is newer than the firmware version number 21 of the first read/write memory chip 131 or not. For example, comparing the numbers, the larger the number, the newer the version. If so, the programming control chip 12 loads the firmware file 31 into the first read/write memory chip 131 to update the firmware program 20 that is stored in the first read/write memory chip 131.

The mobile power supply C may be conformed to interface specifications such as USB 1.0, USB 1.1, USB 2.0 or USB 3.0, or a Type-C USB power supply device such as a USB mobile power supply. The storage device B and the mobile power supply C are selectively and electrically connected to the port 111 of the data transmission interface 11 of the electronic lock A. When the mobile power supply C is electrically connected to the data transmission interface 11 of the electronic lock A via the port 111, the central processing module 10 may use the mobile power supply C as the main power source of the electronic lock A, and continuously control the charging of the battery 15 with the mobile power supply C. The mobile power supply C is available through the port 111. The inserted design enables the electronic lock A to be connected to the external mobile power supply C through the port 111 when the battery 15 is exhausted, so that the electronic lock A is not completely unusable.

In the aforementioned first embodiment of the present invention, each read/write memory chip 13 such as the first read/write memory chip 131, the second read/write memory chip 132, the third read/write memory chip 133, and the fourth read/write memory chip 134 are electrically connected to the programming control chip 12, respectively. So that the central processing module 10 can read the chip identification code 32 of the firmware file 30 and use the programming control chip 12 to select the pre-loaded read/write memory chip 13, and the function of the programming control chip 12. After each read/write memory chip 13 is directly and electrically connected to the central processing module 10, the central processing module 10 can load the firmware file 30 into the pre-loaded read/write memory chip 13.

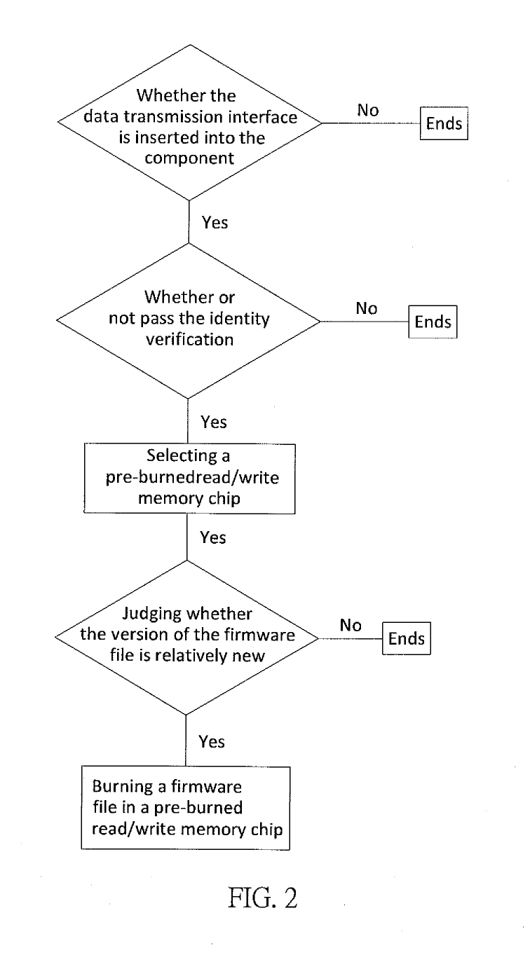

With reference to FIGS. 1 and 2, when the first embodiment of the present invention is in use, the flow of steps includes:

Whether the data transmission interface is inserted into the component: the storage device B is inserted into the port 111 of the data transmission interface 11 of the electronic lock A, and if the central processing module 10 detects the storage device B stores the firmware file 30 that confirms to the format, this is, the firmware file 30 including the version number 31 and the chip identification code 32, proceeding the next step of passing the identity verification. If the storage device B does not include the compatible firmware file 30, and then the process ends.

Whether or not pass the identity verification: the central processing module 10 determines whether the key input by the identity verification module 17 is correct or not, and if it is correct, proceed to the next step of selecting a read/write memory chip 13 to be loaded, if it is wrong, then end the program.

Selecting a pre-loaded readlwrite memory chip: the central processing module 10 may select a pre-loaded read/write memory chip 13 according to the chip identification code 32 of the firmware file 30.

Judging whether the version of the firmware file is relatively new: the central processing module 10 compares the version number 31 of the firmware file 30 with the firmware version number 21 of the pre-loaded readlwrite memory chip 13, if the version number 31 is newer than the firmware version number 21, proceed the next step of loading the firmware file in the read/write memory chip, and if the version number 31 is not newer than the firmware version number 21, terminate the process.

Loading a firmware file in a pre-loaded read/write memory chip: the central processing module 10 instructs the programming control chip 12 to load the firmware file 30 in the pre-loaded read/write memory chip 13 to update the firmware program 20 of the pre-loaded read/write memory chip 13 to the newer version.

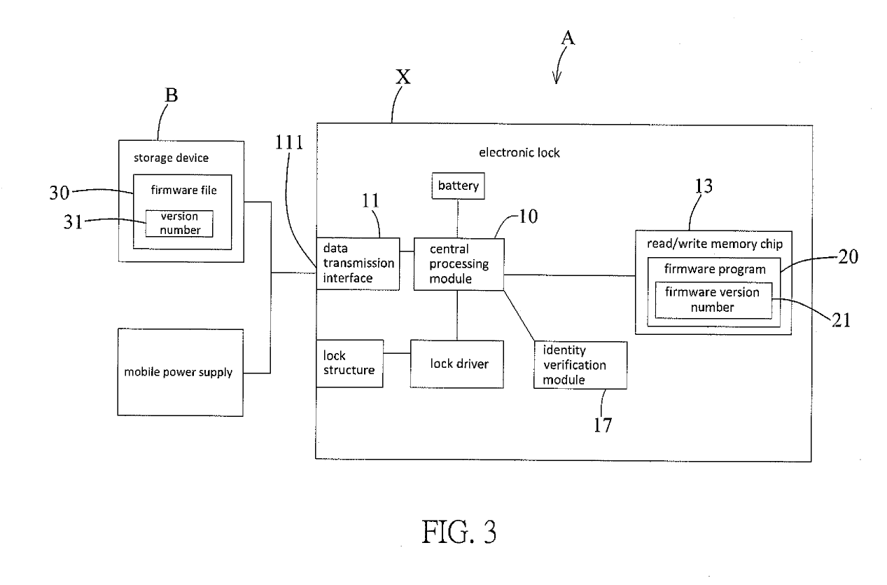

In the first embodiment of the present invention, the electronic lock A has at least two read/write memory chips 13 in the body X, such as the first read/write memory chip 131, the second read/write memory chip 132, the third read/write memory chip 133, and the fourth read/write memory chip 134. With reference to FIG. 3, a second embodiment of the present invention, the electronic lock A has only one read/write memory chip 13.

With further reference to FIG. 3, in the second embodiment of the present invention, the read/write memory chip 13 is directly and electrically connected to the central processing module 10, and has a firmware program 20 with a firmware version number 21. The structures of the electronic lock A of the second embodiment are same as the structures of the electronic lock A of the first embodiment of the present invention, and are not described in detail. In the second embodiment of the present invention, the storage device B has a firmware file 30, and since the electronic lock A has only on read/write memory chip 13 without a selecting process, the firmware file 30 only has a version number 31 without a chip identification code 32.

When the second embodiment of the present invention is in use, since the electronic lock A only has one read/write memory chip 13, and it is unnecessary to identify the firmware file 30 to select a pre-loaded read/write memory chip in the first embodiment, and so the steps may be simplified as:

When the storage device B is inserted into the port 111 of the data transmission interface 11 of the electronic lock A, and if the central processing module 10 detects the storage device B stores the firmware file 30 that confirms to the format, proceeding the next step of passing the identity verification by determining whether the key input by the identity verification module 17 is correct or not, and if it is correct, proceed to the next step of judging whether the version number 31 of the firmware file 30 is relatively newer than the firmware version number 21 of the read/write memory chip 13. If the version number 31 of the firmware file 30 is newer than the firmware version number 21 of the read/write memory chip 13, the firmware file 30 is loaded in the read/write memory chip to update the version of the firmware program 20.

When the first embodiment and the second embodiment of the present invention are in use, the steps of whether to pass the authentication and whether to determine whether the version of the firmware file is relatively new are performed. But the related hardware and software correspond to the two steps of the present invention can be canceled, so that the electronic lock system after cancellation can skip the two steps when it is used. After the step of whether the data transmission interface is inserted into the component, the firmware file to be received without authentication will not be authenticated. In the old and new version of the firmware program 20, a read/write memory chip 13 is loaded, and the firmware program 20 in the read/write memory chip 13 is overwritten.

When the first embodiment and the second preferred embodiment of the present invention are used, the step of selecting a pre-loaded read/write memory chip, which is to be loaded, is except performed by the chip identification code 32 of the firmware file 30, and can also select a pre-loaded read/write memory chip corresponding to the firmware file 30 to be loaded through the command of the identity verification module 17 in the form of the keyboard input module.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

LISTING OF REFERENCE NUMBERS

| | | | |
|---|---|---|---|
| 10 | central processing module | 11 | data transmission interface |
| 12 | programming control chip | 13 | read/write memory chip |
| 131 | first read/write memory | 132 | second read/write memory |
| | chip | | chip |
| 133 | third read/write memory | 134 | fourth read/write memory |
| | chip | | chip |
| 14 | lock driver | 15 | battery |
| 16 | lock structure | 17 | identity verification module |
| 20 | firmware program | 21 | firmware version number |
| 30 | firmware file | 31 | version number |
| 32 | chip identification code | A | electronic lock |
| B | storage device | C | mobile power supply |
| X | body | 111 | port |

What is claimed is:

1. A system of an electronic lock for updating a firmware of the electronic lock having an electronic lock with a body, and the body having a central processing module, a data transmission interface electrically connected to the central processing module, and at least one read/write memory chip electrically connected to the central processing module, wherein
the data transmission interface has a port mounted on a surface of the body, and the port receives a firmware file;
each one of the at least one read/write memory chip stores a firmware program;
the central processing module loads into the firmware file in a corresponding one of the at least one read/write memory chip to become the firmware program.

2. The system of an electronic lock for updating a firmware of the electronic lock as claimed in claim 1, wherein the central processing module has an identity verification module, the central processing module loads into the firmware file in the memory chip while the identity verification module receives, authorize and verify an input key.

3. The system of an electronic lock for updating a firmware of the electronic lock as claimed in claim 2, wherein
each firmware program has a firmware version number;
the firmware file has a version number;
the firmware file is input from the data transmission interface, and the central processing module uses the version number to compare with the firmware version number of the firmware program of the corresponding read/write memory chip; and
the central processing module loads into the firmware file in the corresponding read/write memory chip when the version number of the firmware file is newer than the firmware version number of the firmware program of the corresponding read/write memory chip.

4. The system of an electronic lock for updating a firmware of the electronic lock as claimed in claim 3, wherein the firmware file has a chip identification code, and the central processing module selects a corresponding read/write memory chip by the chip identification code of the firmware file.

5. The system of an electronic lock for updating a firmware of the electronic lock as claimed in claim 4, wherein the electronic lock has a programming control chip electrically connected between the central processing module and the at least one read/write memory chip, and the central processing module loads into the firmware file in the corresponding read/write memory chip by the programming control chip.

6. The system of an electronic lock for updating a firmware of the electronic lock as claimed in claim 1, wherein
the system has a storage device cooperated with the port of the data transmission interface;
the firmware file is stored in the storage device;
the central processing module reads and authorize and verify the firmware file in the storage device when the storage device is connected to the data transmission interface via the port; and
the data transmission interface receives the firmware file when the firmware file is stored in the storage device.

7. The system of an electronic lock for updating a firmware of the electronic lock as claimed in claim 2, wherein
the system has a storage device cooperated with the port of the data transmission interface;
the firmware file is stored in the storage device;
the central processing module reads and authorizes and verifies the firmware file in the storage device when the storage device is electrically connected to the data transmission interface via the port; and
the data transmission interface receives the firmware file when the fumware file is stored in the storage device.

8. The system of an electronic lock for updating a firmware of the electronic lock as claimed in claim 3, wherein
the system has a storage device cooperated with the port of the data transmission interface;
the firmware file is stored in the, storage device;
the central processing module reads and authorizes and verifies whether there is the firmware file in the storage device when the storage device is electrically connected to the data transmission interface via the port; and
the data transmission interface receives the firmware file when the firmware file is stored in the storage device.

9. The system of an electronic lock for updating a firmware of the electronic lock as claimed in claim 4, wherein
the system has a storage device cooperated with the port of the data transmission interface;
the firmware file is stored in the storage device;
the central processing module reads and authorizes and verifies the firmware file in the storage device when the storage device is electrically connected to the data transmission interface via the port; and
the data transmission interface receives the firmware file when the firmware file is stored in the storage device.

10. The system of an electronic lock for updating a firmware of the electronic lock as claimed in claim 5, wherein
the system has a storage device cooperated with the port of the data transmission interface;
the firmware file is stored in the storage device;
the central processing module reads and authorizes and verifies whether there is the firmware file in the storage device when the storage device is electrically connected to the data transmission interface via the port; and
the data transmission interface receives the firmware file when the firmware file is stored in the storage device.

11. The system of an electronic lock for updating a firmware of the electronic lock as claimed in claim 1, wherein
the systein has a mobile power supply cooperated with the port of the data transmission interface; and
the central processing module selects the mobile power supply as the power source of the electronic lock when the mobile power supply is electrically connected to the data transmission interface via the port.

12. The system of an electronic lock for updating a firmware of the electronic lock as claimed in claim 2, wherein
the system has a mobile power supply cooperated with the port of the data transmission interface; and
the central processing module selects the mobile power supply as the power source of the electronic lock when the mobile power supply is electrically connected to the data transmission interface via the port.

13. The system of an electronic lock for updating a firmware of the electronic lock as claimed in claim 3, wherein
the system has a mobile power supply cooperated with the port of the data transmission interface; and
the central processing module selects the mobile power as the power of the electronic lock when the mobile power supply is electrically connected to the data transmission interface via the port.

14. The system of an electronic lock for updating a firmware of the electronic lock as claimed in claim 4, wherein
the system has a mobile power supply cooperated with the port of the data transmission interface; and
the central processing module selects the mobile power supply as the power source of the electronic lock when the mobile power supply is electrically connected to the data transmission interface via the port.

15. The system of an electronic lock for updating a firmware of the electronic lock as claimed in claim 5, wherein
the system has a mobile power supply cooperated with the port of the data transmission interface; and
the central processing module selects the mobile power as the power of the electronic lock when the mobile power supply is electrically connected to the data transmission interface via the port.
